(19) United States
(12) Patent Application Publication
(10) Pub. No.: US 2013/0093357 A1
(43) Pub. Date: Apr. 18, 2013

(54) COLLECTIVE LED INTELLIGENT ILLUMINATION CONTROL DEVICE WITH POWER MEASURING AND MESSAGING FUNCTIONS

(71) Applicants: Cheng-Liang Lee, New Taipei (TW); Hsi Alex Chang, New Taipei (TW); Li-Hung Kuo, New Taipei (TW)

(72) Inventors: Cheng-Liang Lee, New Taipei (TW); Hsi Alex Chang, New Taipei (TW); Li-Hung Kuo, New Taipei (TW)

(73) Assignee: ENERGY INTELLIGENCE CORPORATION, New Taipei (TW)

(21) Appl. No.: 13/274,280

(22) Filed: Oct. 14, 2011

(51) Int. Cl. H05B 37/02

(52) U.S. Cl. 315/297

(57) ABSTRACT

A collective LED intelligent illumination control device includes a power converter for providing the necessary working power supply to a plurality of LED lamps, and a multipurpose controller for dimming control of each said LED lamp which includes a power measurement module for measuring the power consumed by each LED lamp and recording the measured data, a scene mode input interface in conjunction with at least one existing wall switch for group switching and multi-step dimming controls, and a built-in network card and a Zigbee communication interface for communication with a remote server for remote power and dimming controls and collection of power consumption data of each said LED lamp and for wireless communication with surrounding sensors and equipment for predetermined data collection and controls.

### BACKGROUND OF THE INVENTION

(a) Field of the Invention

The present invention relates to illumination control technology and more particularly, to a collective LED intelligent illumination control device, which combines power measurement and communication technologies to establish an information collection platform for intelligent green building for monitoring other sensors or equipment having a Zigbee communication interface, achieving improvement of illumination and outstanding living with energy-saving and carbon-reduction.

(b) Description of the Prior Art

Conventionally the control of lamp is to use one single controller for controlling one single lamp. A wall switch can simply control power ON/OFF or stepped dimming control, not workable for big area illumination switching control, dimming step adjustment control, power consumption data measurement control, timingly or programmed remote server control, or surrounding network control. It does not allow a person to selectively control ON/OFF or dimming of one individual lamp of a group of lamps, or to obtain the power consumption data of every individual lamp, such as the information of failure of one single LED chip or one single series of LED chips of one individual LED lamp. In other words, regular lamp control devices neither provide power measurement, messaging and remote control functions nor allow for change of existing wall switch for group switching and dimming step adjustment without changing the existing electrical wiring. These conventional lamp control devices cannot allow multiple lamps of different specifications to share one single power converter. They cannot detect the normality of the functioning of every individual LED chip or individual series of LED chips in every individual LED lamp.

### SUMMARY OF THE INVENTION

The present invention has been accomplished under the circumstances in view. It is one object of the present invention to provide a collective LED intelligent illumination control device, which comprises one single power converter and multiple dim controllers for providing power supply to multiple LED lamps and controlling their lighting. The collective LED intelligent illumination control device comprises a power measurement module for measuring and recording the power consumed by each individual LED lamp and the total power consumption of all the LED lamps, a scene mode input interface in conjunction with the existing wall switch without changing the electrical wiring of the existing wall switch for group switching and multi-step dimming control, and a Zigbee communication interface for communication with a remote server for periodical or programmed control as well as for communication with the local area network for controlling ON/OFF and light intensity regulation of every LED lamp, inquiry of related power consumption data, and checking of normality of the functioning of every individual LED chip or every series of loop in every individual LED lamp, Subject to the attached Zigbee interface, the collective LED intelligent illumination control device can communicate with surrounding sensors or equipment to establish a wireless network for full-area information collection and control.

It is another object of the present invention to provide a collective LED intelligent illumination control device with power measurement and messaging functions, which enables multiple LED lamps to share one single power converter that provides multiple programmably controlled current sources for controlling the light intensity of multiple LED lamps, improving the operation efficiency and reducing the cost.

It is still another object of the present invention to provide a collective LED intelligent illumination control device, which provides a scene mode input interface to use with the existing wall switch for group switching control and Dip-setting dimming control without changing the existing electrical wiring of the wall switch, enabling the existing single wall switch to be converted into two switches for group switching and multi-step dimming control respectively, satisfying the actual requirements.

It is still another object of the present invention to provide a collective LED intelligent illumination control device, which provides a power measurement module to compute the total power consumption, and to calculate the power consumption of each individual LED lamp subject to the operation of a built-in program. By means of the computing operation of the connected remote server, the power consumption information of every individual LED lamp and the normality of the functioning of every individual LED chip or individual series loop in every individual LED lamp are known, assisting active failure detection, energy-saving and intelligent illumination control.

It is still another object of the present invention to provide a collective LED intelligent illumination control device, which provides a simple information collection and control platform with the built-in network interface for allowing remote on/off and dimming controls of multiple LED lamps programmably or timingly. The built-in network interface allows connection with the local area network for individual lamp ON/OFF and fine dimming control and inquiry of individual lamp power consumption data. By means of built-in Zigbee interface, the collective LED intelligent illumination control device can be connected with surrounding sensors or equipment having Zigbee interface means to establish a network for intelligent green building control.

It is still another object of the present invention to provide a collective LED intelligent illumination control device, which provides a touch interface switch for changing the ON/OFF switching mode of an existing switch, either of 2-wire or 3-wire design to overcome power and control problems without changing the existing electrical wiring. In other words, the invention provides a new electronic touch switch to substitute for a conventional switching type switch, providing group switching and dimming control and establishing a human-friendly, safely n intelligent and control environment.

### BRIEF DESCRIPTION OF THE DRAWINGS

FIG. 1 is an elevational view of a collective LED intelligent illumination control device in accordance with the present invention.

FIG. 2 is a schematic drawing illustrating an application example of the present invention.

FIG. 3 is an exploded view of the collective LED intelligent illumination control device in accordance with the present invention.

FIG. 4 is an architecture block diagram of the collective LED intelligent illumination control device in accordance with the present invention.

FIG. 5(a)˜FIG. 5(c) is a circuit diagram of the power measurement module in accordance with the present invention.

FIG. 6(a)˜FIG. 6(d) is a circuit diagram of the lighting control and status read interface in accordance with the present invention.

FIG. 7(a)˜FIG. 7(c) is a circuit diagram of the microprocessor and periphery control panel and the power protection and control board in accordance with the present invention.

FIG. 8(a)˜FIG. 8(b) is a circuit diagram of the scene mode input interface and the control mode set interface in accordance with the present invention.

FIG. 9(a)˜FIG. 9(c) is a circuit diagram of the TCP/IP to RS-485 converter and data storage interface in accordance with the present invention.

FIG. 10(a)˜FIG. 10(b) is a circuit diagram of the Zigbee wireless communication module in accordance with the present invention.

FIG. 11 is a circuit diagram of the mechanical switch and electronic touch switch attached to the collective LED intelligent illumination control device in accordance with the present invention.

FIG. 12 is a schematic drawing illustrating the arrangement of a dual color temperature LED lamp in accordance with the present invention.

### DETAILED DESCRIPTION OF THE PREFERRED EMBODIMENTS

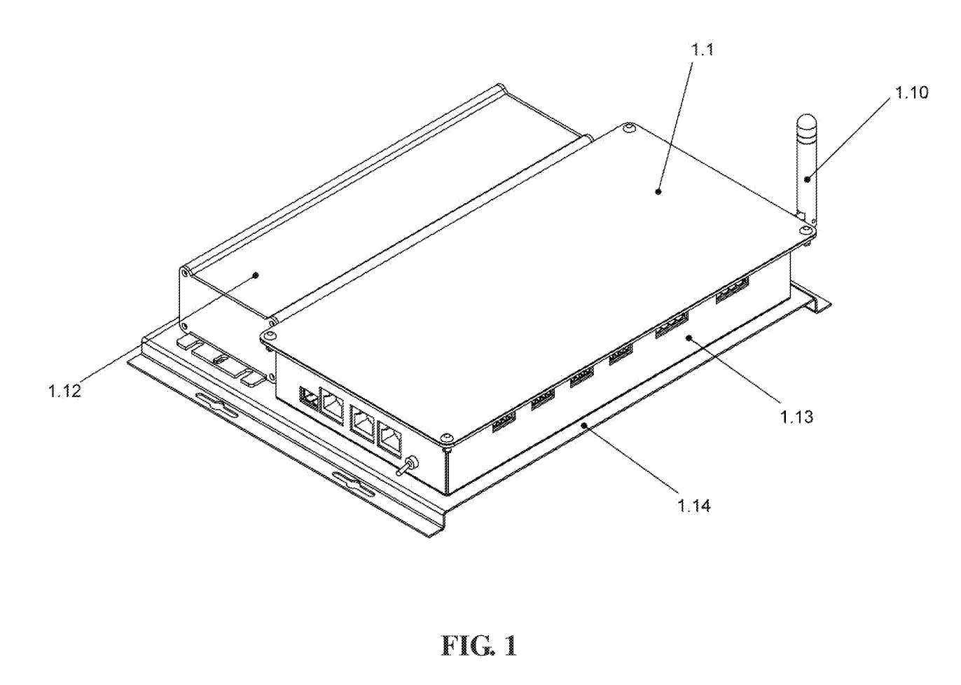

Referring to FIG. 1, a collective LED intelligent illumination control device in accordance with the present invention is shown comprising an A4-sized bottom plate 1.14, a power converter 1.12 and a controller (which comprises a controller top cover 1.2 and a controller housing 1.13) located on the top side of the bottom plate 1.14.

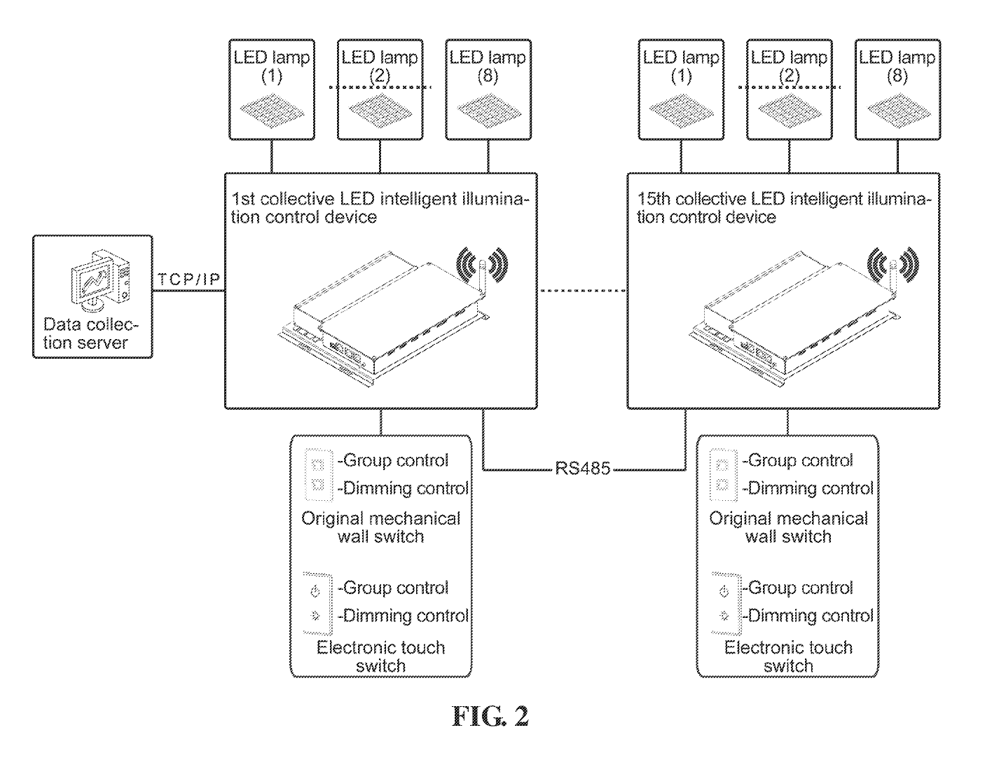

FIG. 2 is a schematic drawing illustrating an application example of the present invention. According to this application example, multiple collective LED intelligent illumination control devices (the maximum is 15) are connected in series by a RS-485 network cable, wherein each collective LED intelligent illumination control device is electrically connectable with two wall switches for controlling 8 LED lamp sets for power measuring, light regulating and message transmitting controls.

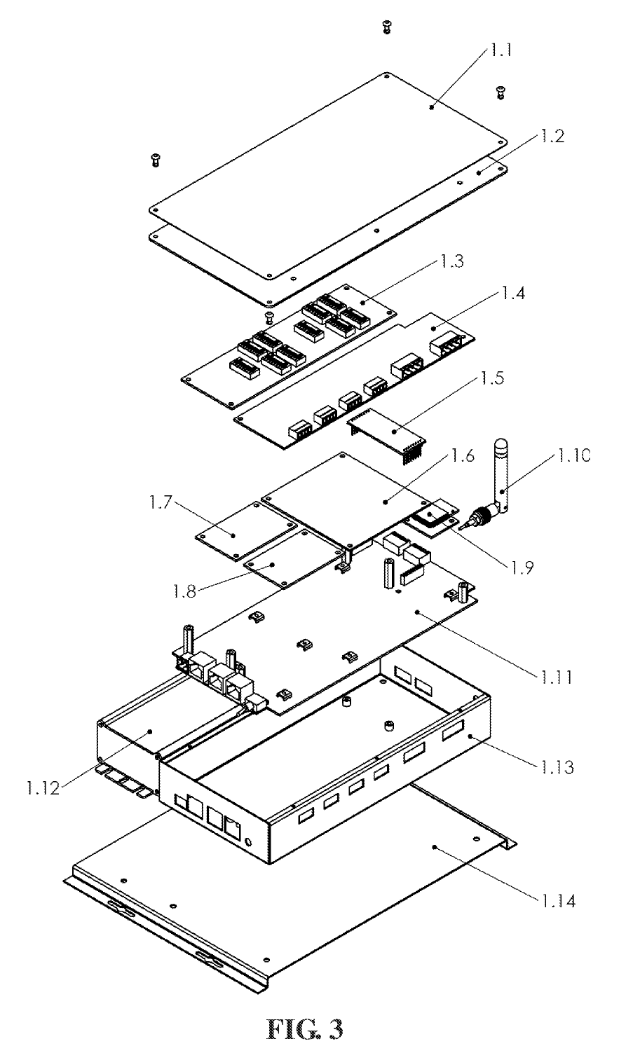

Referring to FIG. 3, the collective LED intelligent illumination control device includes the component parts: nameplate 1.1; controller top cover 1.2; scene mode input interface 1.3; lighting control and status read interface board 1.4; power measurement module 1.5; microprocessor and periphery control panel 1.6; TCP/IP to RS-485 converter and data storage board 1.7; power protection and control board 1.8; Zigbee wireless communication module 1.9; Zigbee external antenna 1.10; adapter board 1.11, 48V power converter 1.12; controller housing 1.13; bottom plate 1.14.

As illustrated, the collective LED intelligent illumination control device is assembled subject to the follow steps. Affix the adapter board 1.11 to the inside of the controller housing 1.13, and then mount the power measurement module 1.5, the microprocessor and periphery control panel 1.6, the TCP/IP to RS-485 converter and data storage board 1.7, the power protection and control board 1.8 and the Zigbee wireless communication module 1.9 on the adapter board 1.11, and then mount the scene mode input interface 1.3 and the lighting control and status read interface board 1.4 at the top side to finish the arrangement and fixation of all PC boards, and then fasten the Zigbee external antenna 1.10 to the controller housing 1.13, and then fasten the controller top cover 1.2 and the nameplate 1.1 to the controller housing 1.13 to protect all the internal components. Thus, the collective LED intelligent illumination control device is assembled as shown in FIG. 1.

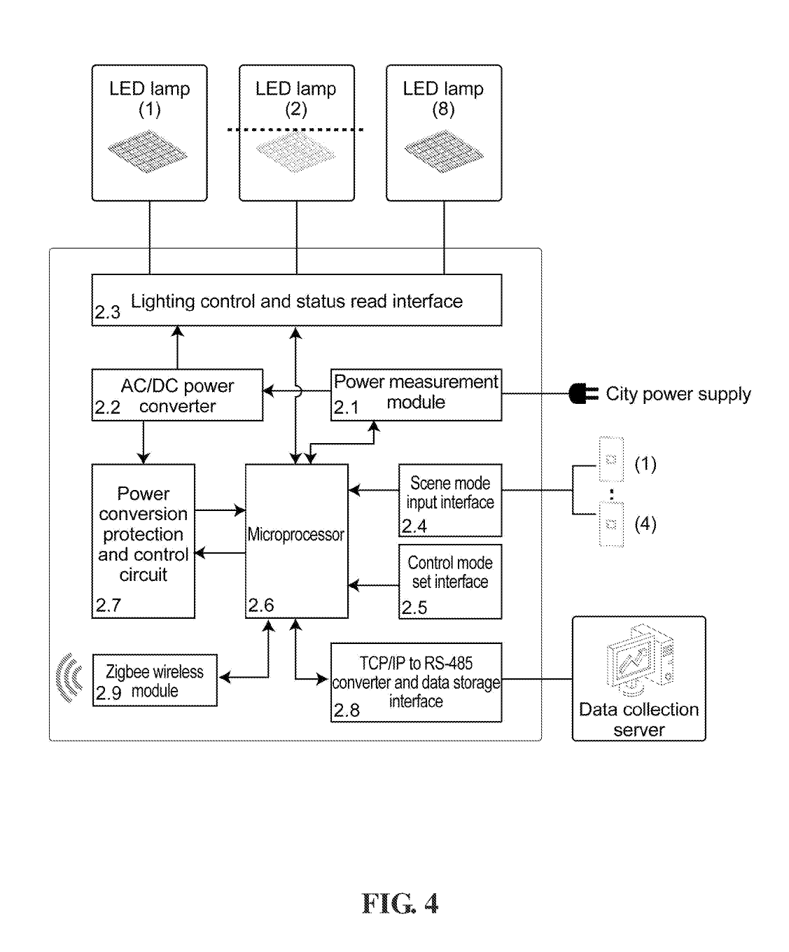

FIG. 4 is an architecture block diagram of the collective LED intelligent illumination control device in accordance with the present invention. External city power supply is inputted into power measurement module 2.1 and then transmitted to AC/DC power converter 2.2 for measurement of all power consumption data, and the measured data is then read and recorded by microprocessor 2.6.

DC power supply outputted by AC/DC power converter 2.2 is mainly provided to lighting control and status read interface 2.3 for lighting up 8 external LED lamps. Further, a minor part of DC power supply outputted by AC/DC power converter 2.2 is provided to power conversion protection and control circuit for system operation.

Microprocessor 2.6 detects external wall switch status subject to scene mode input interface 2.6. Subject to set data from control mode set interface 2.5, microprocessor 2.6 drives lighting control and status read interface 2 to control and read the brightness of the 8 external LED lamps and the related power consumption data.

Further, microprocessor 2.6 can communicate with remote data search server via TCP/IP to RS-485 converter and data storage interface 2.8 to control lighting control and status read interface 2.3 in controlling and reading the brightness of the 8 external LED lamps and the related power consumption data, and to transmit the obtained data to remote server.

Except of controlling and reading LED brightness and power consumption data subject the control of microprocessor 2.6, TCP/IP to RS-485 converter and data storage interface 2.8 can also communicate with Zigbee wireless module 2.9 by means of its serial communication interface for controlling and reading other external equipment or sensors. During communication, microprocessor 2.6 can overlook the communication status. If there is any communication abnormality, microprocessor 2.6 immediately starts up power conversion protection and control circuit 2.7 to reset TCP/IP to RS-485 converter and data storage interface 2.8 and Zigbee wireless module 2.9, enhancing communication reliability.

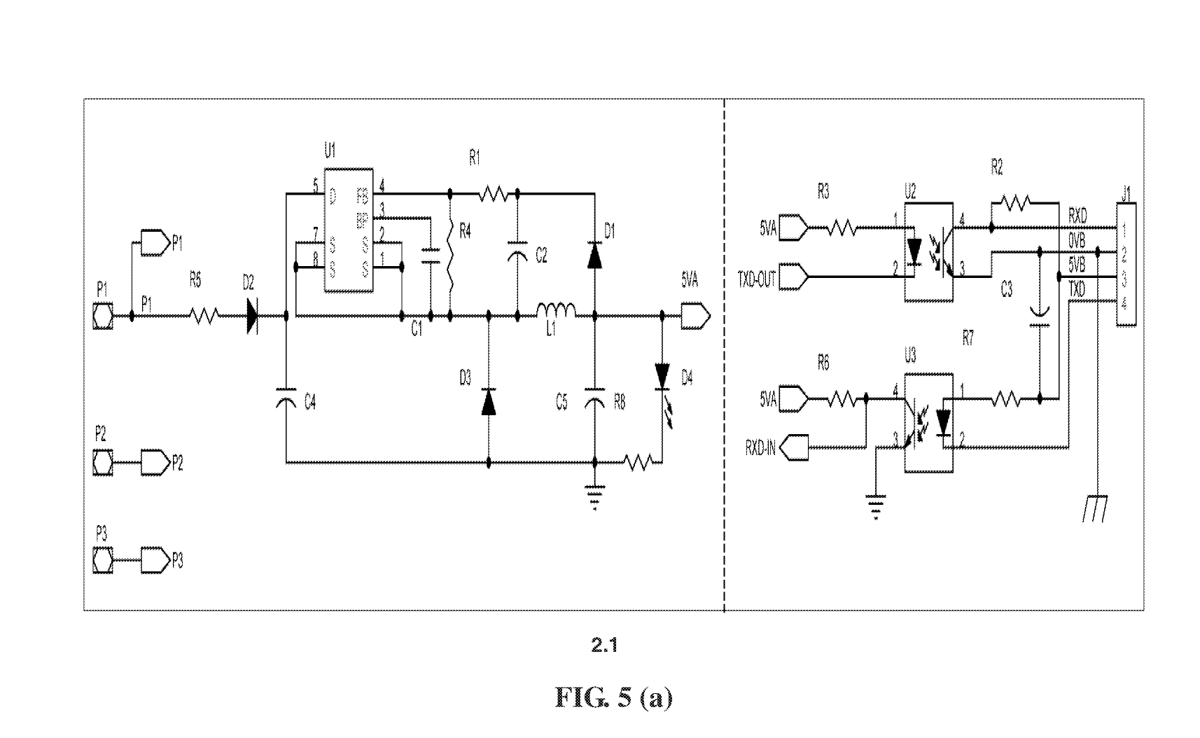

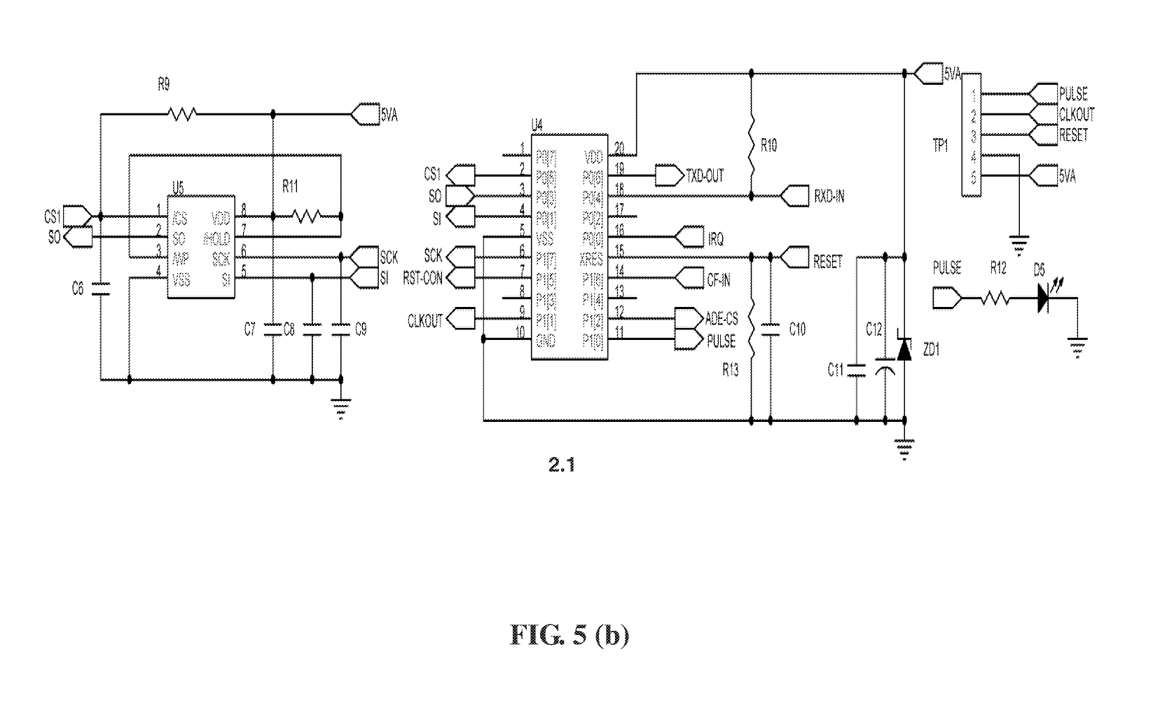

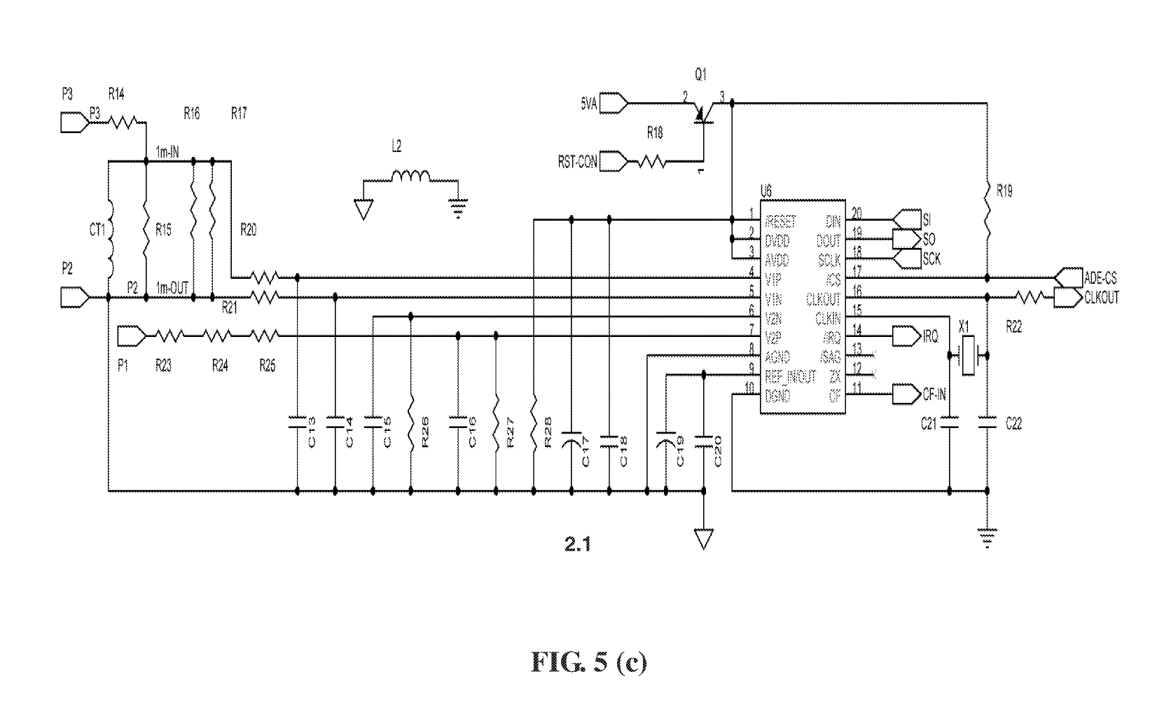

The operating principle and effects of each block of the collective LED intelligent illumination control device of the present invention will be outlined hereinafter with reference to the circuit diagrams of the system blocks shown in FIGS. 5-10 and the attached mechanical switch and electronic touch switch.

FIG. 5(a)˜FIG. 5(b) is a circuit diagram of the power measurement module (block 2.1) in accordance with the present invention. In the drawing, U1 is a switch type power stabilizer IC; city power supply P1 goes through R5, D2 to drain pole of U1 (PIN 5); hundreds of volts DC power supply at C4 is processed through U1, D1, D3, R1, R4 and C1, C2, C5 and L1 into the desired 5 VA for the present module. The power value is determined subject to resistance ratio of R1 and R4. D4 and R8 are 5 VA power indicator lights. This 5 VA power supply is simply provided for power measurement module.

In FIG. 5(c), U6 is a power measurement IC. Inputting a proper ratio of city power supply voltage and current consumption into U6 can obtain the data of voltage (V), current (A), power (W), real work (Wh) and power factor (PF) from U6. U6 obtains input voltage from P1, which is then shunted through R23, R24, R25 and R27. In other words, voltage of R27 is inputted in direct ratio into P1. There are two choices for the current detection signal provided by U6. Under the condition of large current (over 15A), P2 and P3 go through current transformer CT1 via a conductor, and the secondary current causes the formation of a corresponding voltage at R15. This voltage is directly proportional to the electric current consumed (R16 and R17 are not installed at this time). The detected current signal goes through R20 and R21 to pin VIP and pin VIN of power measurement IC U6. In this example, the total power consumed is less than 300 W, and therefore CT1 and R15 are not used to detect the current. Instead, low-resistance resistors R16 and R17 are used. Voltages at the two ends of resistors R16 and R17 are read. These voltages are also directly proportional to the current consumed.

In FIG. 5(c), resistors and capacitor, at the signal input end of U6, including C13, C14, C15, C16, C17 and R26, are adapted for removing noises from the signal to be examined. Power measurement IC U6 uses the voltage at its PIN-9 as the reference voltage for measurement. C19 and C20 are adapted for stabilizing the reference voltage. X1 is a precision oscillator for use as a counting time base during measurement as well as a basic time base during energy (Wh) conversion. The measurement results are transmitted from S1, S0 and SCK through signal lines to MCU of U4. In other words, MCU (U4) reads power measurement data from U6 by means of SPI (serial peripheral interface) bus. In the drawing, Q1 is controlled by U4 to power-off and power-on reset U6 when U6 is abnormal. Microprocessor U4 can store calibrated data in memory U5. During operation, microprocessor U4 uses signal lines CS1, SO, SI and SCK to read corrected data, and to load the data into a register of power measurement IC U6 through signal lines ADE-CS, SO, SI and SCK. Microprocessor U4 also uses the same signal lines to read the value measured by U6 and to load the data into the memory IC of U5. Microprocessor U4 can also transmit measurement data through signal lines TXD-OUT and RXD-IN to pins RXD and TXD of J1 via photo isolator IC U2 and U3, enabling master CPU to read real-time or historical measurement data from the present power measurement module through TXD and RXD.

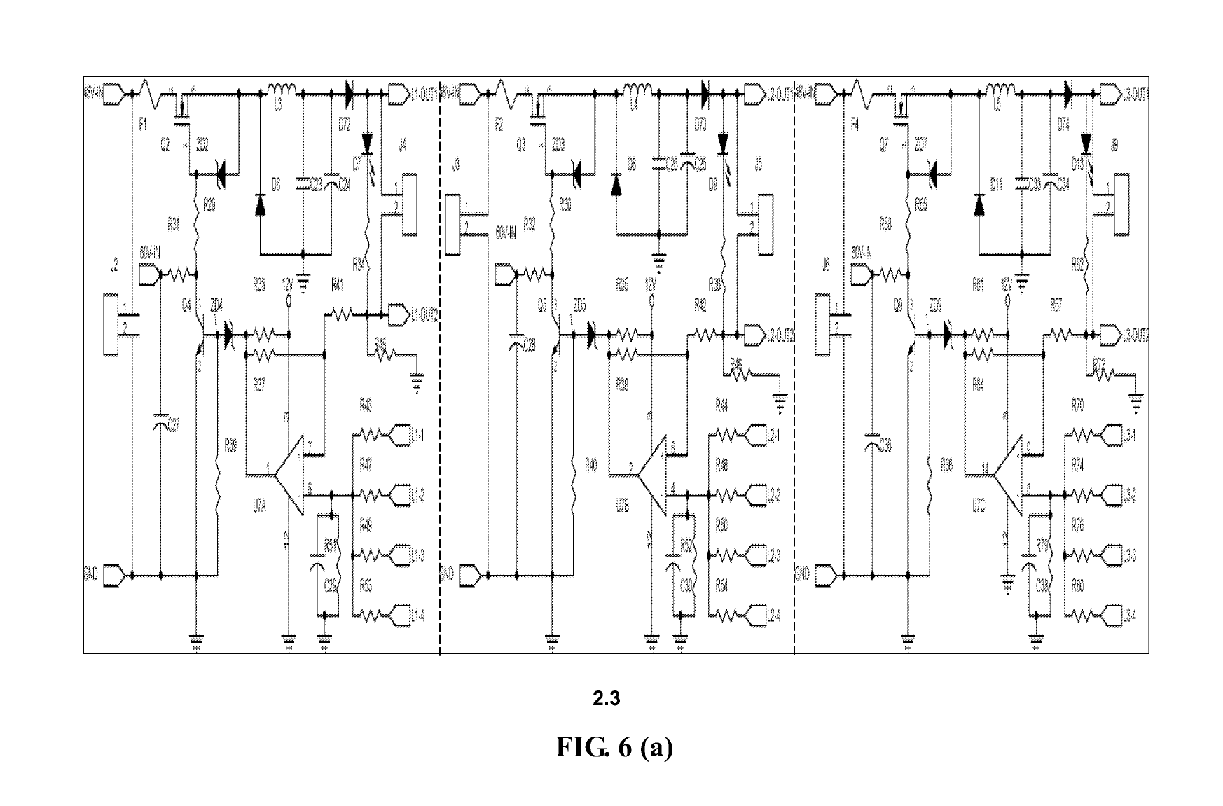

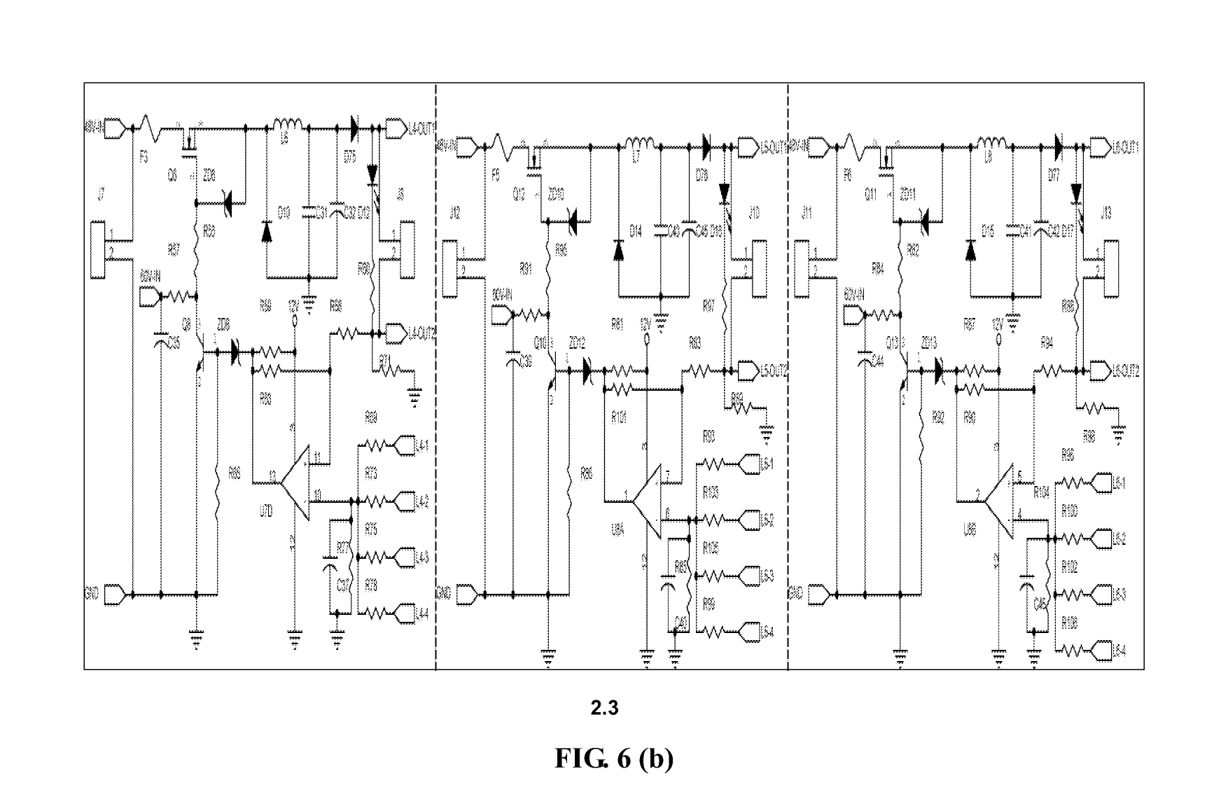

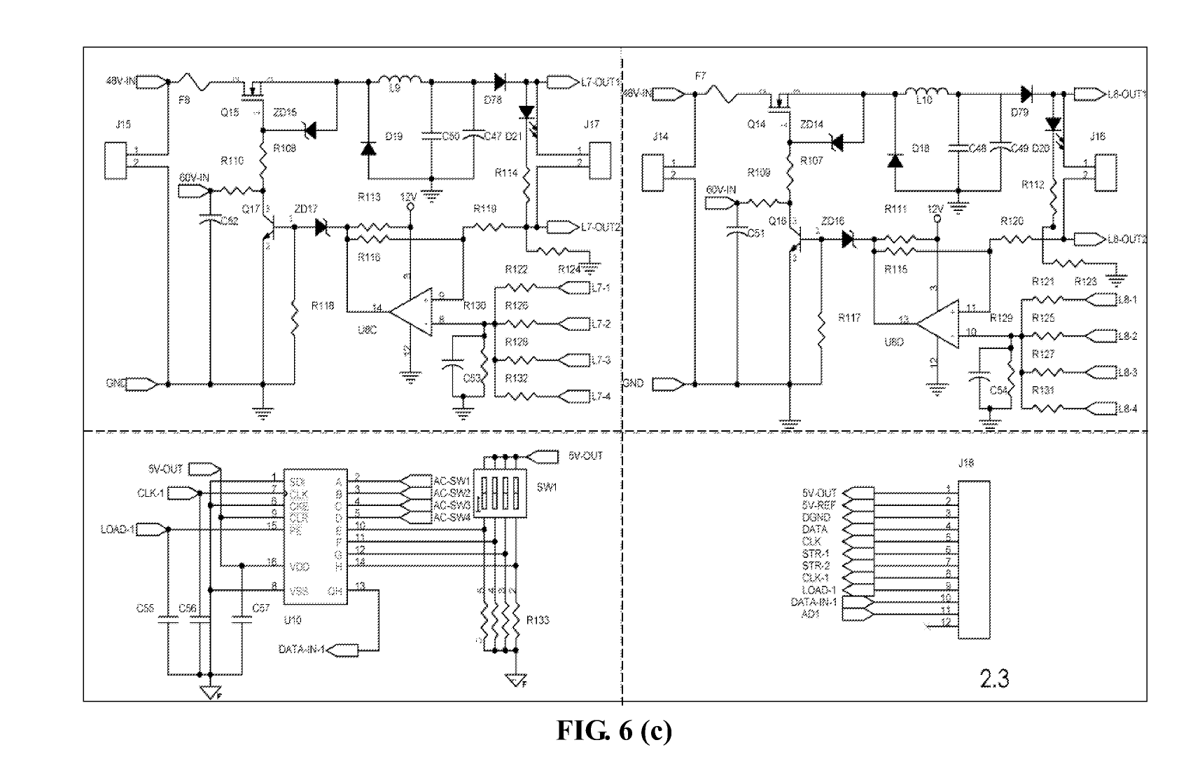

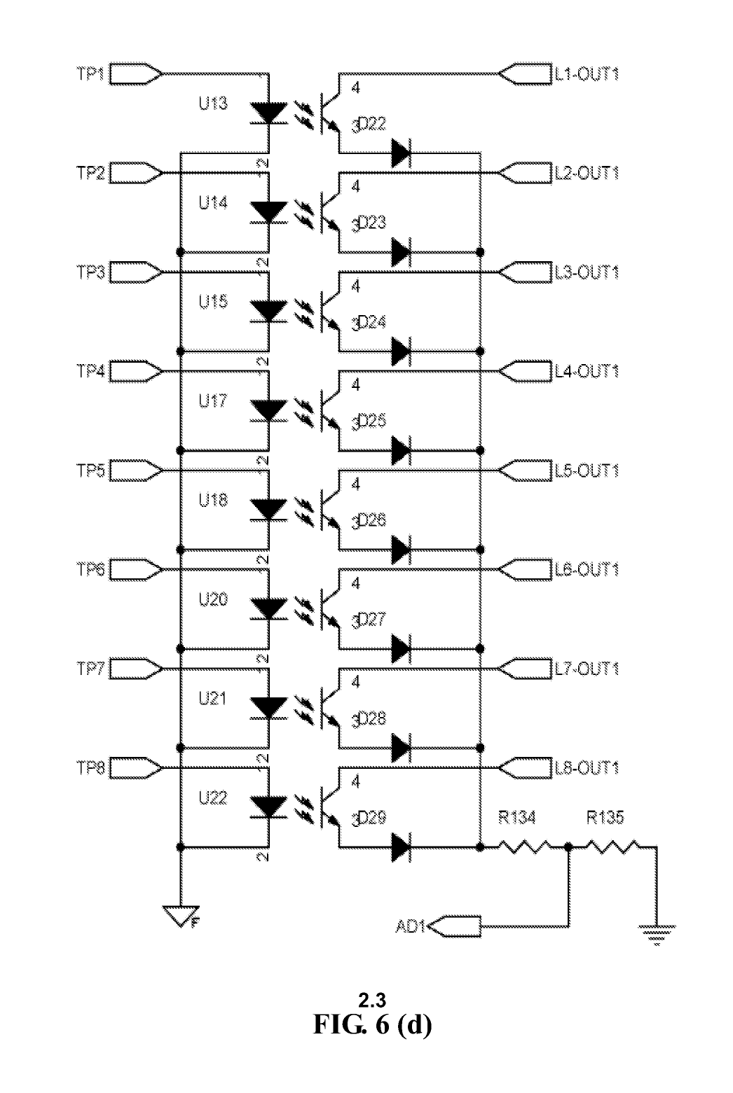

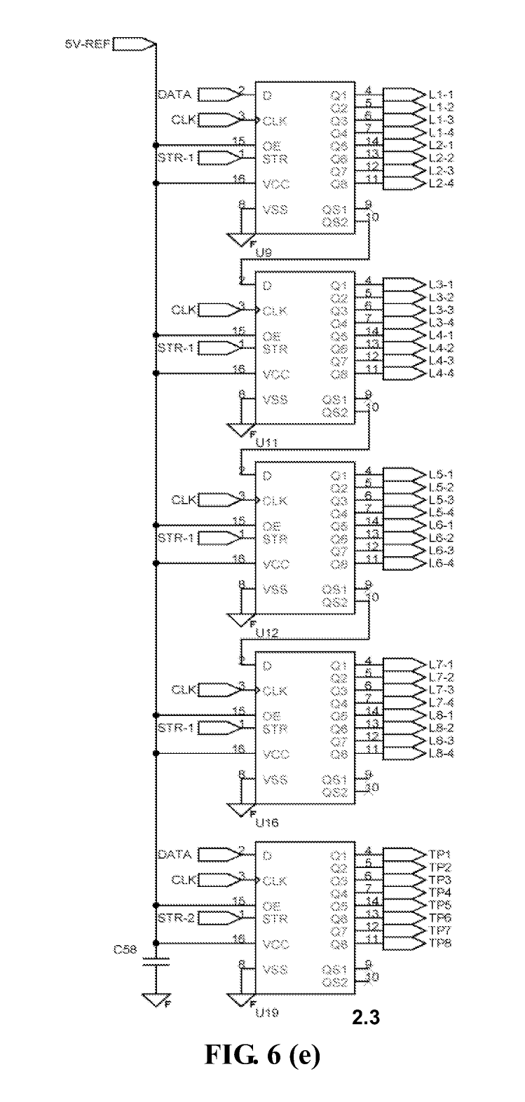

FIG. 6(a)˜FIG. 6(d) is a circuit diagram of the lighting control and status read interface (block 2.3) in accordance with the present invention, in which, LED controls numbered 1 through 8 for controlling 8 LED lamps respectively. As LED controls numbered 1 through 8 have the same circuit structure and work in the same manner, 1st LED control is explained as an example. As illustrated, power converter provides 48V DC power supply through fuse F1 to Q2. In the drawing, L1-OUT1 and L1-OUT2 are electrically connected to the respective external LED lamp; R45 is a current detection resistor, i.e., the higher the voltage at R45 is, the greater the current provided to the external LED lamp will be. It is directly proportional. In the drawing, U7A is a comparator. As illustrated, when the input at the negative terminal (PIN-6) of U7A is greater than its positive terminal (PIN-7), it means the current provided to the LED lamp is below the set current value. At this time, the output of U7A becomes LOW, turning the collector of Q4 into HI to conduct Q2 in increasing the voltage to the LED lamp, and therefore the brightness is enhanced. When increasing the current, the voltage at R45 is relatively increased, and the output of U7A will become HI to turn on Q4 and to turn off Q2 when the input at the positive terminal (PIN-7) of U7A becomes equal to the input at the negative terminal (PIN-6) of U7. In other words, changing L1-1, L1-2, L1-3 and L1-4 between HI and Low automatically control the voltage and current provided to the external LED lamp, thereby controlling the brightness. In this circuit, four logic input voltages L1-1, L1-2, L1-3 and L1-4 are processed through R43, R47, R49 and R53 at a respective resistance ratio and then shunt through R51 to provide one of 16 voltages (24=16), i.e., total 16 dimming current levels or 16 dimming brightness levels. In other words, the invention converts 4 digital voltage levels into 16 linear voltages for setting 16 dimming currents.

In FIG. 6(a), 60V-IN (60V) provides a higher voltage than power supply 48V. This voltage is guided through C27 and R31 to drive Q2. R29 and ZD2 are adapted for limiting and protecting the drive voltage for Q2. Further, D6;L3 and C23;C24 constitute a switching type energy-storage circuit; R37 and R41 form a Schmitt circuit, enabling comparator U7A to control ON or OFF of Q2 stably. Subject automatic control of the voltage at R45 (i.e., the current to lighting on LED) and the voltage at R51 (the current to conduct LED), ON or OFF of Q2 is automatically controlled. By means of smooth filtration through L3 and C23 and C24, the current of the LED output voltage satisfies the set brightness and kept in proximity to a constant DC current value (not a regular PWM manner), achieving high-efficiency and low-loss performance and keeping. Thus, the invention eliminates the problems of non-uniform LED brightness, flashing, noise production and transient overload driving, and prolongs the lifespan of the LED lamps.

In FIG. 6(d), serial-in/parallel-out IC U16 provides 8 signals TP1˜TP8 for controlling ON and OFF of 8 photo isolator ICs U13˜U22. The first photo isolator IC is explained as an example. As illustrated, TP1 controls ON or OFF of photo isolator IC U13. Matching with D22 at the shunt circuit of R134 and R135, a voltage directly proportional to the output voltage of LED-1 is obtained. The circuit principle and working manner of the other LED control 2nd through 8th are same as LED control-1. No further detailed description in this regard is necessary. In other words, controlling TP1˜TP8 can start the respective photo isolator ICs to measure the current drive voltages of the respective LED lamps subject shunting through R134 and R135 and conversion through AD1, thereby overlooking the power consumption and status of the respective LED lamps. In this embodiment, the LED lamps are respectively composed of serially and parallelly connected individual LED chips. By means of current-limit control and output voltage measurement of the lighting control and status read interface, the invention can know whether or not the functioning of every individual LED chip, every series circuit and every parallel circuit is normal, facilitating active failure repair or collection of data including operating illumination time. Further, U9, U11, U12 and U16 are serial-in/parallel-out ICs for controlling total 32 digital output points. Each 4 digital output points of the total 32 digital output points are arranged in a set for controlling the brightness of one respective LED lamp, and therefore the total 32 digital output points can control the brightness of 8 LED lamps. In other words, U19 can take turns to control the reading of the output voltage of any LED lamp that is been driven on. Matching with the current under control, the energy consumed and the operating status of every LED lamp are calculated. In the drawing, U10 is a parallel-in/serial-out IC for reading 4 statuses of 2 wall switches and 4 DIP (dual in-line package) switches SW1. These switches can set the connection address of the present invention for communication, total 0˜F for selection. Thus, one TCP/IP network card allows connection of 15 collective LED intelligent illumination control devices, i.e., for the control of total 120 LED lamps (8×15=120) and collection and calculation of power consumption data and operating status data.

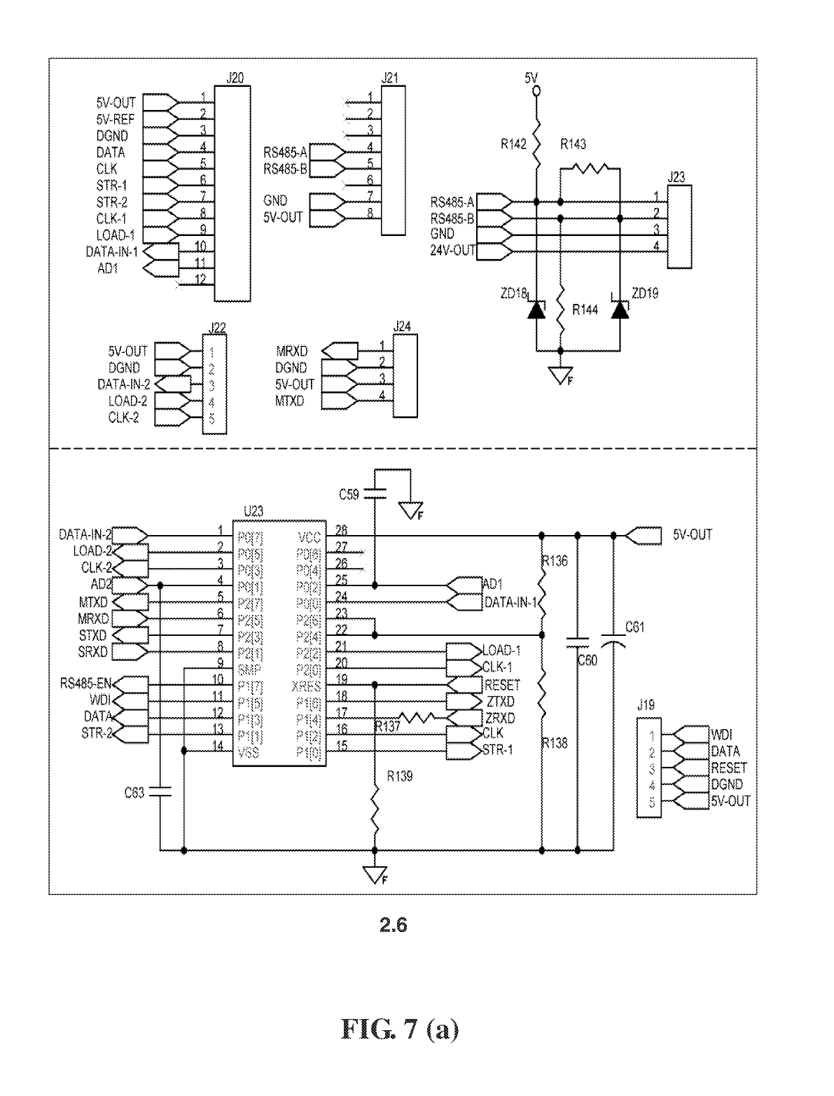

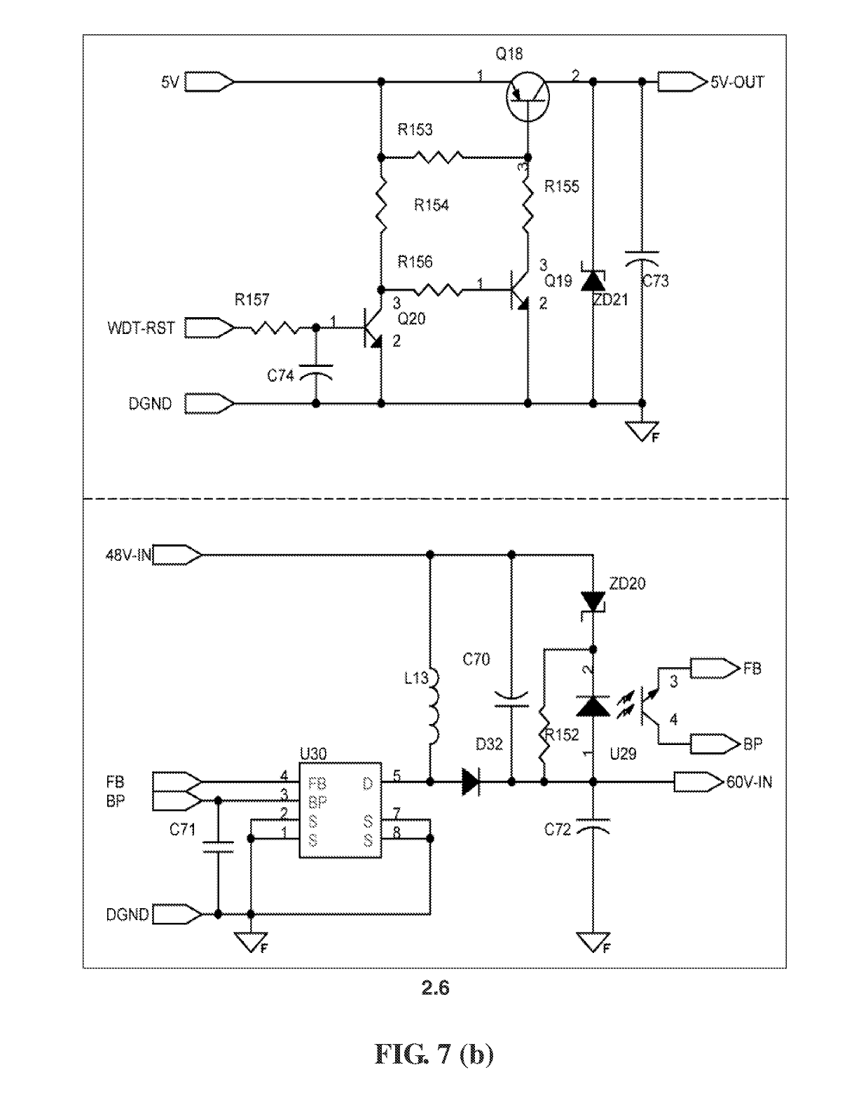

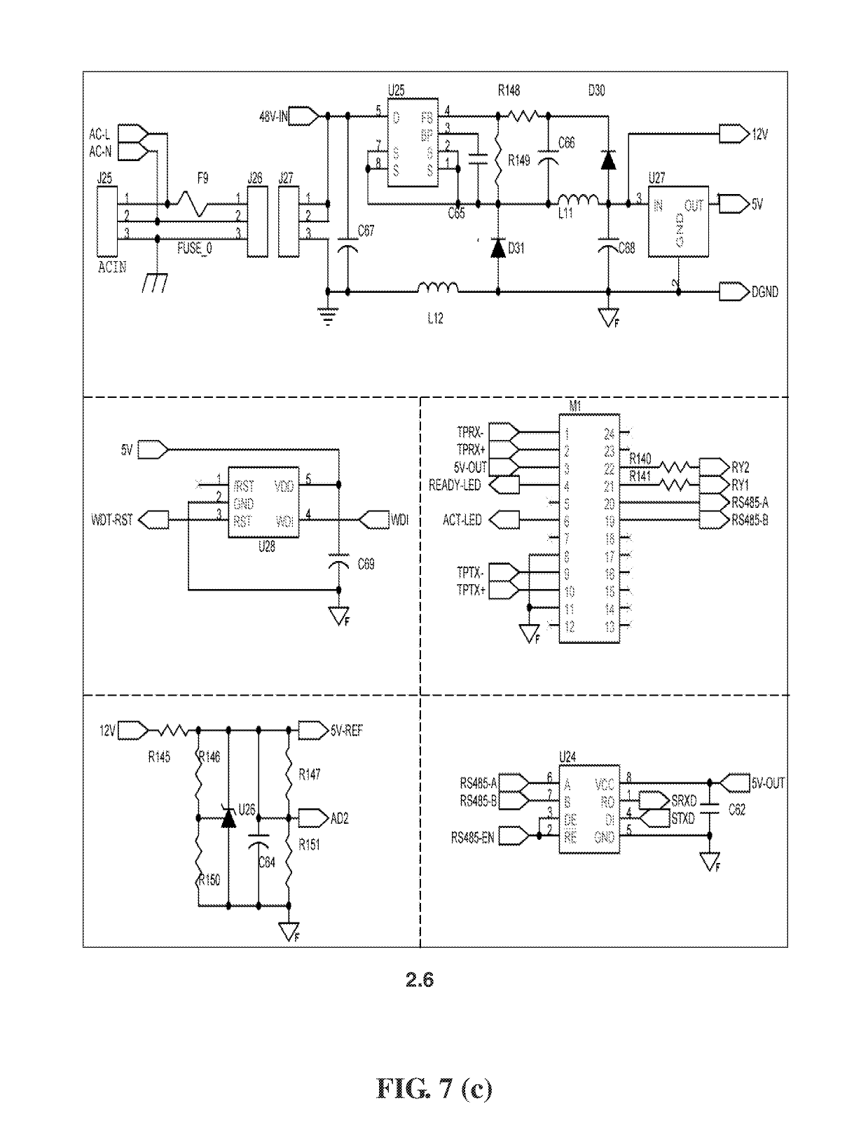

FIG. 7(a)˜FIG. 7(c) is a circuit diagram of the microprocessor and periphery control panel and the power protection and control board (circuit diagram of block 2.6 and circuit diagram of block 2.7) in accordance with the present invention. In the drawing, microprocessor IC U23 has a memory built therein for storing an execution program. It is the control center of the present invention. By means of the signal lines of the control pins TXD and RXD, microprocessor IC U23 reads power measurement data from power measurement module 2.1. By means of signal lines DATA, CLK and STR-1 and digital outputs of U9, U11, U12 and U16, microprocessor IC U23 controls LED drive voltage and current of lighting control and status read interface 2.3. By means of signal line STR-2 and output control of U19, microprocessor IC U23 can read the output value. By means of signal lines CLK1, LOAD1 and DATA-IN-1, microprocessor IC U23 can control U10 to receive the current status of scene mode input interface 2.4. By means of signal lines CLK2, LOAD2 and DATA-IN-2, microprocessor IC U23 can also control U35˜U44 to read the set value of control mode set interface 2.5 for controlling lighting control and status read interface 2.3, i.e., controlling the wall switches subject to the mode set by the user. Thus, the invention achieves on-site intelligent lighting control.

Further, by means of signal lines SRXD, STXD and RS-485-EN, RS-186 converter IC U24 and TCP/IP to RS-485 converter and data storage interface 2.8, microprocessor IC U23 can also be connected to a remote server for remote control through the internet. Further, by means of signal line WD1 and power conversion protection and control circuit 2.7 to maintain normal operation. In case of any abnormality, pulse input of WDI (PIN-4) of U28 shown in FIG. 7(c) can be interrupted to reset power supply, i.e., WDI signal will disappear if the operation of the system (program) becomes abnormal, or, WDT-RST(PIN-3) of U28 will be changed from LOW to HI if the system voltage (5V) is abnormal, thereby conducting Q20 and changing Q19 and Q18 into OPEN status, i.e., cutting off power supply (PIN-28) of microprocessor IC U23, or changing 5V-OUT to 0V. Immediately thereafter, power supply is resumed to finish the procedure of POWER ON RESET, re-starting the system.

As shown in FIG. 7(c), the desired low voltage 5V power supply is provided by the external AC/DC 48V power source that is processed through switch type power supply IC U25 and the peripheral D30, D31, R148, R149, C66, C67, C68, L11 and L12, and therefore stabilized 5V is obtained for the operation of every block circuit.

Referring to FIG. 7(b) again, the necessary driving power 60V POWER MOS (60V-IN) is obtained by boosting 48V-IN. In the drawing, switch type power supply IC U30 works with D32 and ZD20 (12V Zener diode) and components R158, U29, C70 and C71, 48V is boosted for extra 12V to provide 60V output for driving POWER MOS of every dimmer.

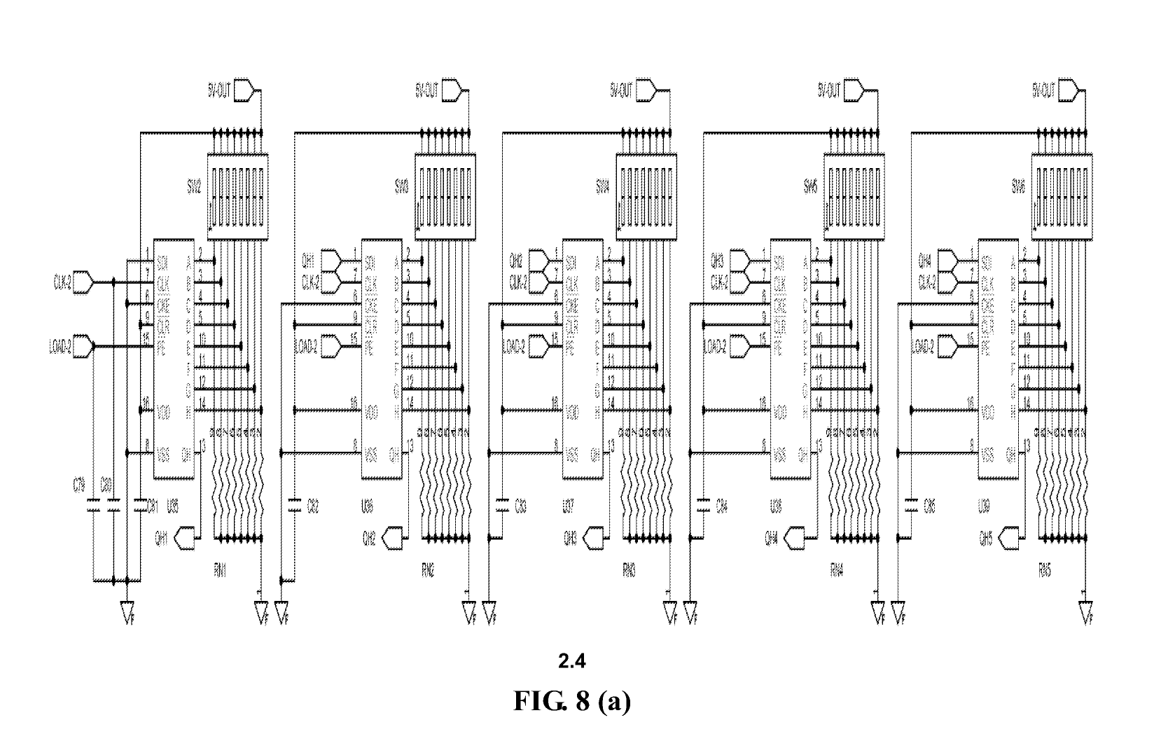

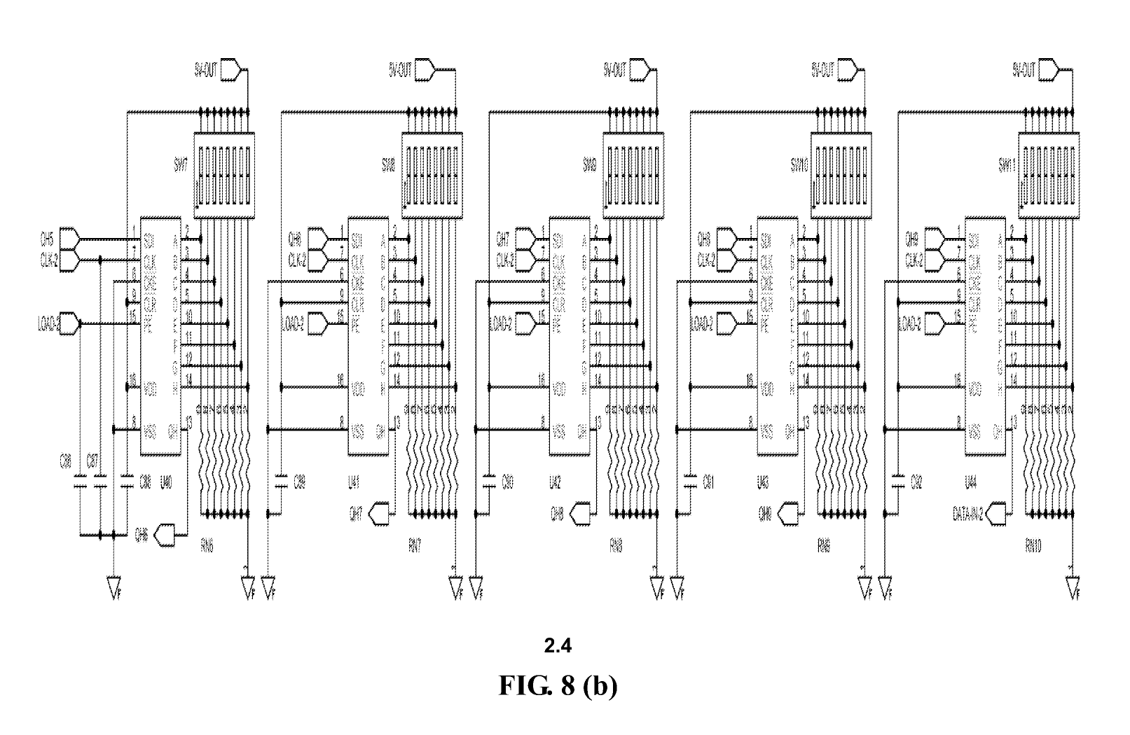

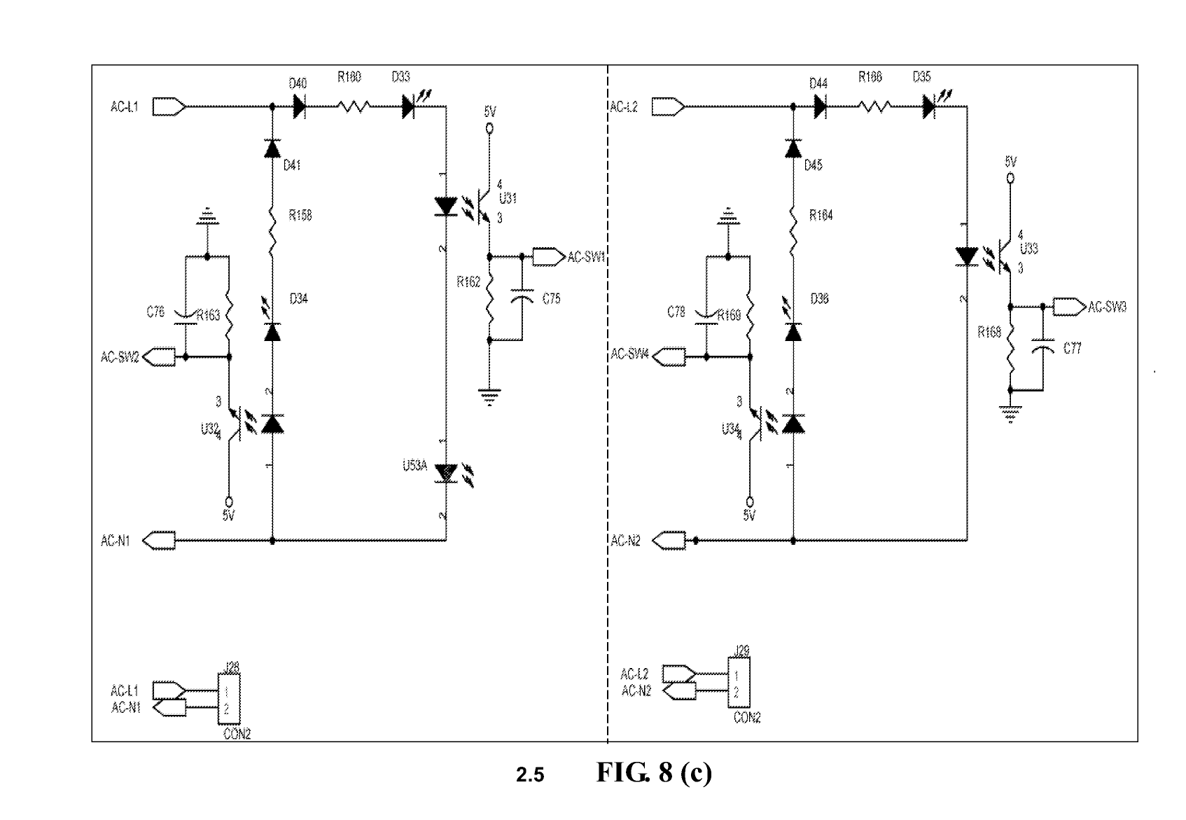

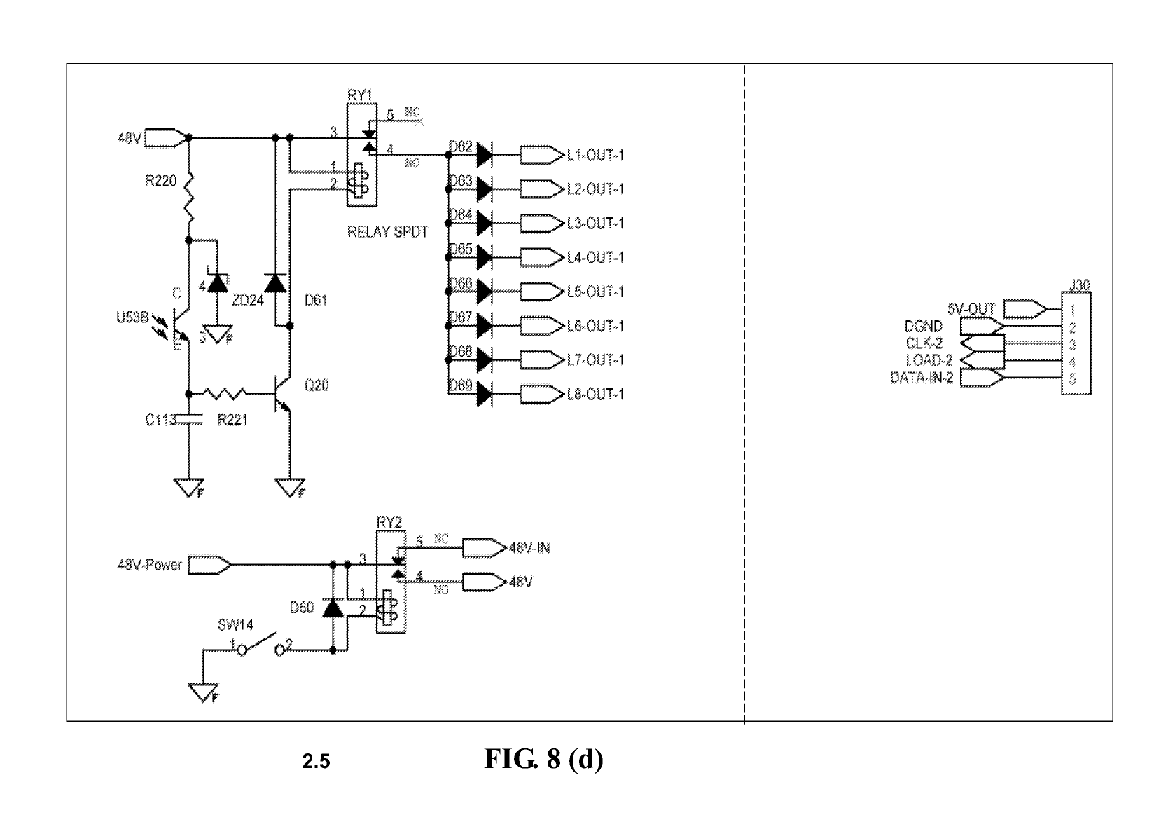

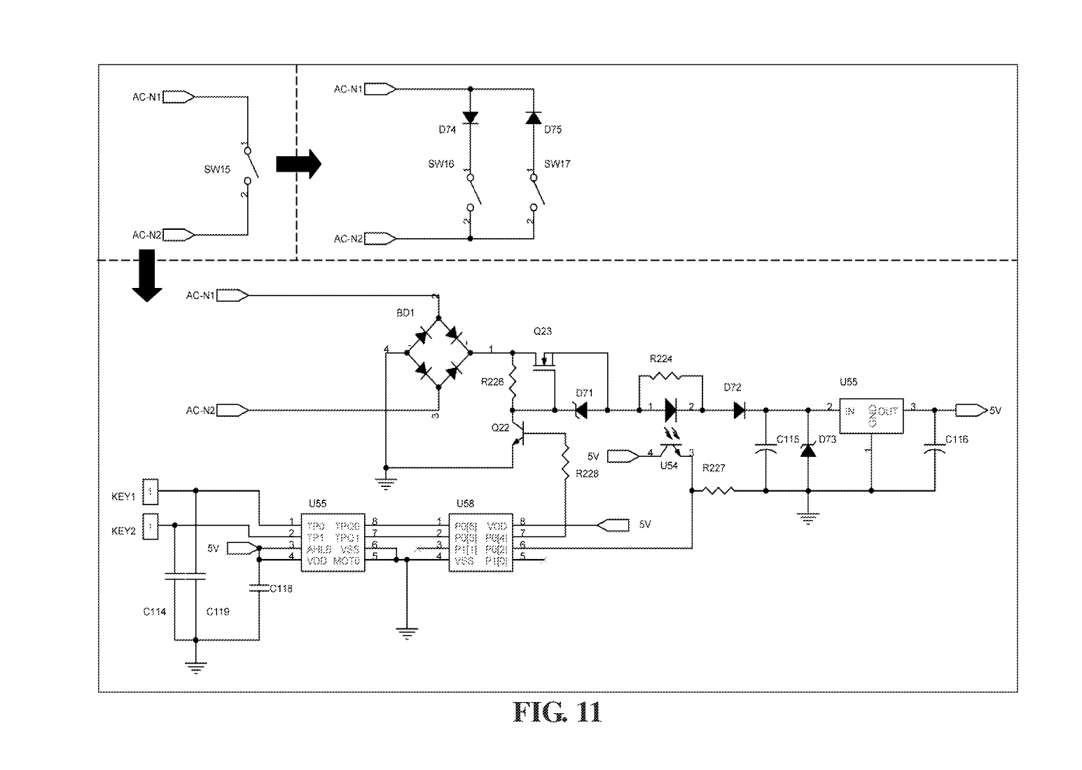

FIG. 8(a)˜FIG. 8(b) is a circuit diagram of the scene mode input interface and the control mode set interface (circuits of block 2.4 and block 2.5) in accordance with the present invention. The invention uses the original wall switches and defines 2 switches for 4 statuses. As illustrated, AC-L1 and AC-N1 represent the light source controlled by the original switch, thus the original switch wiring can be used without any change. When the switch is ON, an alternating voltage is provided between AC-L1 and AC-N1. This alternating voltage is divided into positive and negative loops by D40 and D41. As illustrated, positive half cycle is sent through D40, R160, D33, U31 and U53, in which D33 is an LED indicator light; U31 and U35 are photo isolator ICs. If the original switch is ON, U31 is conducted during positive half cycle, enabling R162 to obtain 5V high potential, i.e., AC-SW1 is at positive potential. During negative half cycle, electric current goes through D41, R158, D34 and U32, in which R158 is a current-limiting resistor; D34 is a LED dimming indicator light; U32 is a photo isolator IC. If the original switch is ON, U32 is conducted during negative half cycle, enabling R163 to obtain 5V high potential. If two wall switches are used to substitute for the original wall switch, these two wall switches are respectively connected with one respective diode, enabling one wall switch to be conducted during positive half cycle for controlling the potential of AC-SW1 for group control and the other wall switch to be conducted during negative half cycle for controlling the potential of AC-SW2 for dimming control. In other words, two wall switches can be used to substitute one wall switch without changing the electrical wiring, constituting an operating interface for group control and dimming control. The resistance of R158 is deliberately designed to be smaller than R160. Thus, when the wall switch is ON, the current at negative half cycle is greater than the current at positive half cycle. This design matches the attached electronic touch switch (see FIG. 11) for measuring positive and negative half cycles for enabling positive half cycle to be employed for group control and negative half cycle to be employed for dimming control synchronously. Thus, the electronic touch switch can achieve the controls same as the aforesaid two mechanical switches. AC-SW3 and AC-SW4 correspond to the other wall switch or an attached electronic touch switch to achieve the same control objectives in a different operating manner. Signal lines AC-SW1˜AC-SW4 are obtained indirectly by microprocessor IC U23 through parallel-in/serial-out IC U10, i.e., microprocessor can detect ON or OFF message of the wall switch at any time and analyzes the meaning of continuous switch, enabling the built-in program of microprocessor IC U23 to execute on/off and brightness controls of the lamp subject to the user's desire.

As illustrated in FIG. 8(b), the area around the 4 wall switches is divided into two zones each having 2 wall switches installed therein, wherein AC-SW1 defines the wall switch group in Zone 1; AC-SW2 defines the dimming switch in Zone 1; AC-SW3 defines the wall switch group in Zone 2; AC-SW4 defines the dimming switch in Zone 2. In the circuit diagram shown in FIG. 8(a), SW2, SW3, SW4 and SW5 are 8-way Dip switches each representing one LED lamp. To match with the content of the LED lamp to be lighted upon each switching action of AC-SW1, for example, SW2 has its 1st, 2nd, 3rd and 4th ways defined to be ON and its 5th, 6th, 7th and 8th ways defined to be OFF and SW4 has its 1st defined to be ON and its 2nd through 8th ways defined to be OFF, thus, when AC-SW1 is firstly switched, 1st through 4th LED lamps are turned on, and the 1st LED lamp is turned on upon second switching action of AC-SW1, and so on in the third and fourth switching actions, In other words, SW1˜SW4 can set the definition of each switching action (of the total four switching actions) of AC-SW1. SW5 is an 8-way Dip switch having its 1st through 7th ways set to define a respective dimming ratio for each of total 7 switching actions of AC-SW2. In this example, the dimming ratio is 100% for the first switching action, 80% for the second switching action, 60% for the third switching action, 50% for the fourth switching action, 40% for the fifth switching action, 10% for the sixth switching action, and 5% for the seventh switching action. For example, if LED lamp is ON when SW5 is switched to the 1st, 4th or 6th way, or OFF when SW5 is switched to any of the other ways, thus, switching AC-SW2 OFF-ON each time, dimming of the LED lamp will be changed from 100% (full light) to 50% (half light) and then to 10% (dim light), and so on. In other words, by means of switch setting, original wall switches are arranged for group switching and dimming control. Switching setting can be made easily and conveniently subject to the job-site requirements to save power consumption.

In FIG. 8(a)˜FIG. 8(b), every switch corresponds to one parallel-in/serial-out IC, for example, SW1 corresponds to U1; SW2 corresponds to U2, and so on. Subject to CLK-2, LOAD-2 and DATA-IN-2 signal combination of the microprocessor, every switching message of SW-1˜SW-10 can be read into microprocessor U11. Matching existing wall switches AC-SW1˜AC-SW4 with the operation of the built-in program of U11, a group of LED lamps is accurately controlled subject to requirements. Further, the 8th way of SW5 and SW10 is defined for self-test of group settings and dimming settings for quick understanding of the relationship between each LED lamp and the respective group and auto establishment of dimming data of each LED lamp for further reference in dimming control and active maintenance. For example, when SW10 is set to be ON, microprocessor program will start to establish the dimming data of every LED lamp. It starts to regulate the light intensity of the first LED lamp from the first step (as stated above, L1˜L4 of U9 can control dimming in 16 steps including one step to be OFF), and then to read the driving voltage of each LED lamp under control (as stated above, subject to control of TP1˜TP8, driving voltage of each LED lamp is alternatively measured from AD1) and to record the related data. After dimming of the 16th step, repeat the same procedure to establish the dimming data of the second LED lamp till establishment of the dimming data of the 8th LED lamp is done. In other words, this function can automatic establish the driving voltage for every dimming step for every LED lamp, and there are total 128 data (16 steps×8 pcs of lamps). Through program computing, the maximum current of every LED lamp under 48V driving voltage for 100% brightness is obtained. Thus, the amount of electric current for every dimming step for every LED lamp can be set. Even different types of LED lamps are used, they can be calculated for automatic intelligent dimming control. Further, the driving voltage corresponding to the electric current for every dimming step for every LED lamp is also established at the same time. In actual application, the driving voltage of every LED lamp is automatically measured can calculated. When surpassed a predetermined ratio of error, it means a LED chip or loop failure in the respective LED lamp. For example, when SW5 is ON, microprocessor program initiates a self-test procedure to test the first LED at first. Subject the set number of dimming steps, it starts from the step of full light and then runs automatically step by step to the last dimming step, and then turn on the second LED lamp and repeat the procedure, and repeat the procedure to test the next LED lamp until the test of the last LED lamp is done. This test procedure is repeatedly until that SW5 is set to be OFF. Thus, the engineer or the user can rapidly recognize the relationship between every LED lamp and the respective group and the related dimming status.

In FIG. 8(a)˜FIG. 8(b), an emergency switch is designed, for example, SW14. Normally, SW14 is kept in the normal position where external 48V-POWER goes through NC contact of RY2 to 48V-IN, and is then converted into 12V, 5V, 60V (see FIG. 7a˜7c) and LED driving power supply (see FIG. 6a˜6d). When an abnormality or failure occurs, SW14 is switched to the position of transient state. At this time, RY2 works, 48V-POWER goes through NO contact of RY2, and all the aforesaid power supply are off with the limited surrounding circuits of the emergency switch are allowed to use this 48V power supply. If the first wall switch is ON at this time, U53 and Q20 will be conducted to change RY1 from OFF to ON, allowing 48V to go through D62˜D69 to positive terminals of L1-OUT˜L8-OUT for turning on the 8 LED lamps, If the wall switch is OFF at this time, RY1 is OFF, and the 8 LED lamps are all turned off. In other words, when the device fails, only a limited number of component parts are electrically conducted, keeping the LED lamps to be all ON or OFF, avoiding any inconvenience.

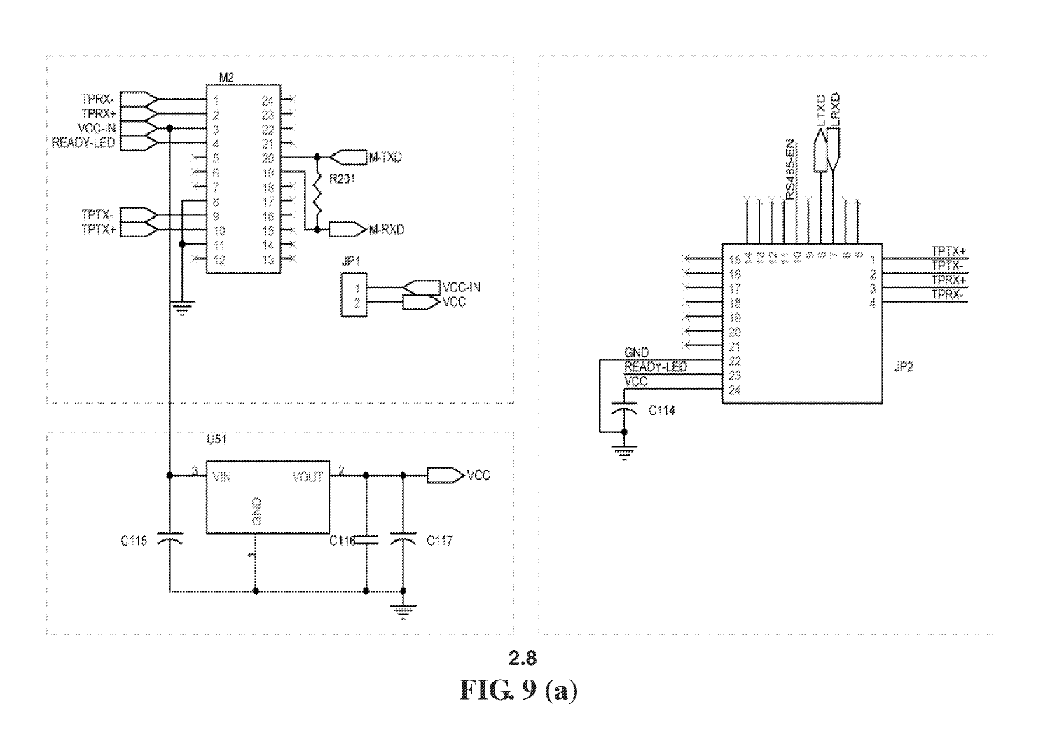

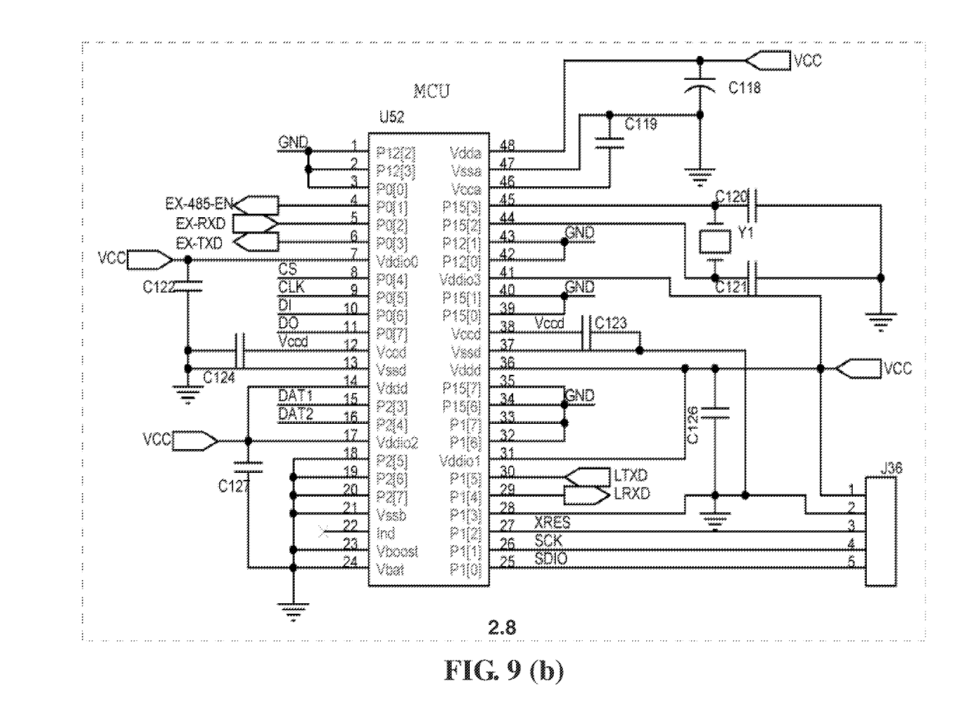

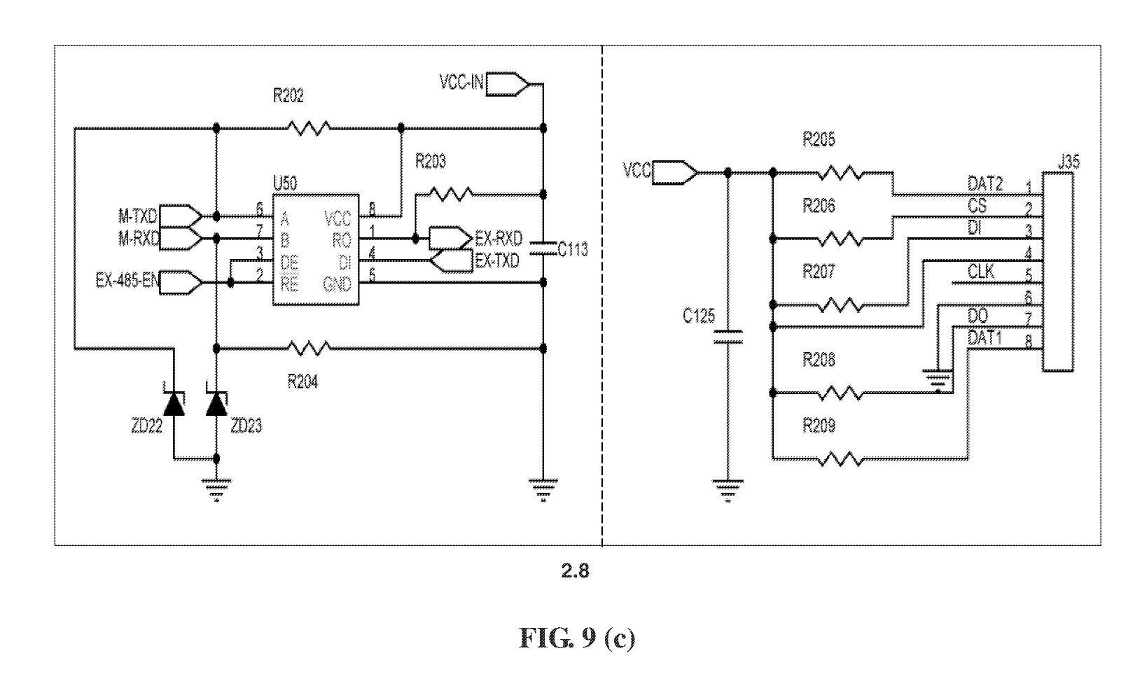

FIG. 9(a)˜FIG. 9(c) is a circuit diagram of the TCP/IP to RS-485 converter and data storage interface (circuit diagram of block 2.8) in accordance with the present invention. RS-485 is used for communication between each two individual collective LED intelligent illumination control devices. Through the network card in this circuit, each collective LED intelligent illumination control device can communicate with a remote server subject to TCP/IP communication protocol. In the drawing, JP2 is a TCP-to-UART converter for converting network signal lines TPTX+, TPTX−, TPRX+ and TPRX− into signal lines LTXD and LRXD for communication with U52; by means of EX-TXD, EX-RXD and EX-485EN and RS-485 converter IC U50, U52 can change the signal lines into M-TXD and M-RXD of RS-485 for communication with other equipment. In other words, the microprocessor in the circuit is in charge of conversion between TCP/IP and RS-485 and communication works to convert signals collected by RS-485 interface into TCP/IP signals via JP2 network card for communication with remote computer or server, and to convert TCP/IP commands from remote server into RS-485 control signals for controlling the operation of the LED lamps. In the drawing, J35 is a memory card connector for receiving a SD memory card for storing collected data. In the drawing, U51 is a 5V to 3.3V buck regulator. As the network card, SD card applicable to the present circuit consumes 3.3V, it is necessary to step down system 5V into 3.3V VCC for application.

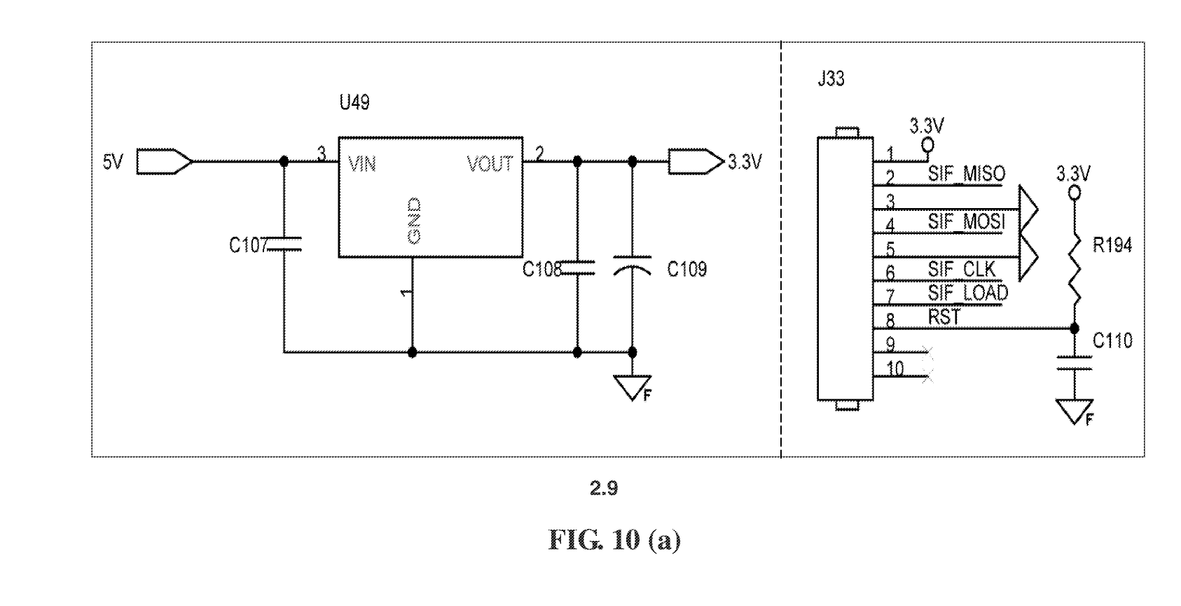

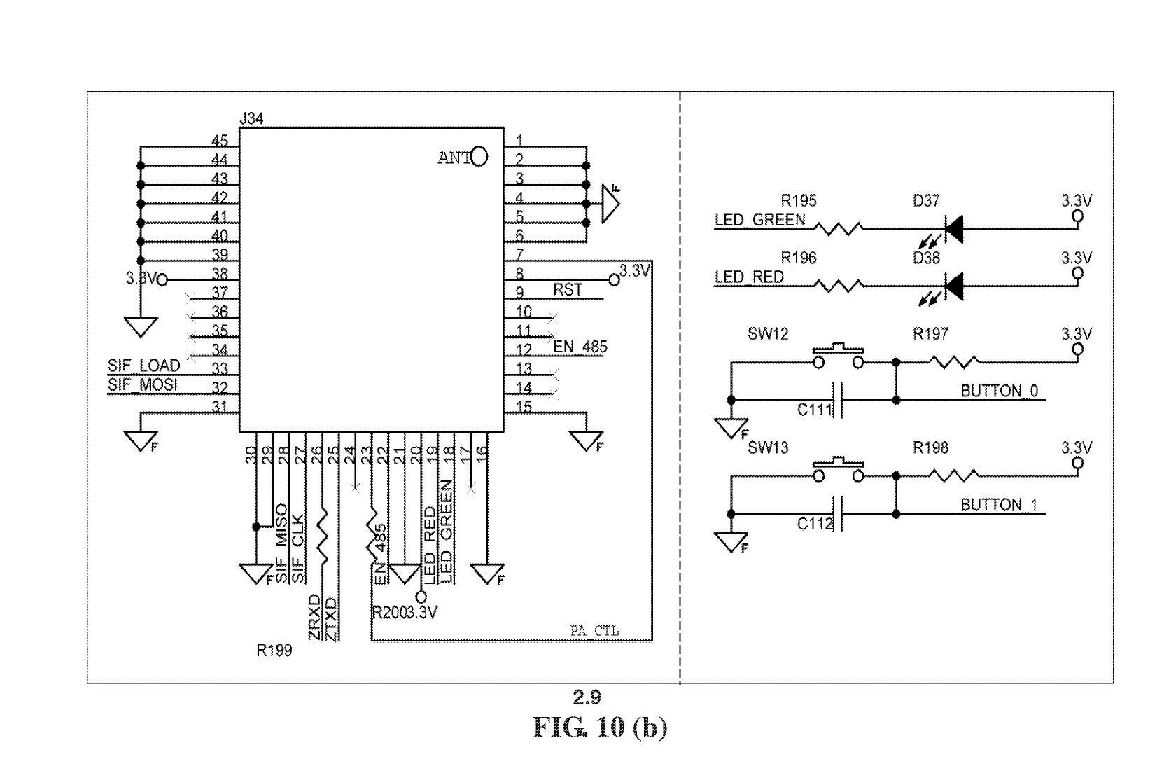

FIG. 10(a)˜FIG. 10(b) is a circuit diagram of the Zigbee wireless communication module (circuit diagram of block 2.9) in accordance with the present invention. Except the function of remote illumination control, the invention also provides Zigbee wireless communication interface for wireless connection to the Internet. The Zigbee module J34 consumes 3.3V power supply. Thus, a 5V to 3.3V buck regulator IC U49 is used to provide stabilized 3.3V for working. By means of ZTXD and ZRXD, Zigbee communication module J34 communicates with microprocessor U23 of FIG. 7(a). As both Zigbee communication module J34 and microprocessor U23 have different voltage potentials, resistor R119 is connected in series therebetween to balance the potentials. In the drawing, D37 and D38 are a matching pair of communication status indicator lights; SW12 and SW13 are a matching pair of operating buttons. In the drawing, J33 is a programmer for Zigbee module; J34 is an external antenna connector for Zigbee module for the connection of an external antenna outside the control box to enhance communication signal quality. As the invention can be installed in the ceiling, it is practical for indoor wireless communication and can be connected to a server. The added Zigbee module enables the collective LED intelligent illumination control device to work as a green intelligent communication platform.

FIG. 11 is a circuit diagram of the mechanical switch and electronic touch switch attached to the collective LED intelligent illumination control device in accordance with the present invention. This attachment is adapted for substituting for the existing one single wall switch without changing any electrical wiring. It provides two switches or two touch buttons for group control and dimming control. The operation principle of this attachment is explained hereinafter. In the drawing SW15 is the original single wall switch, which is substituted by two switches, such as SW 16 and SW17 each has a respective series of diodes D74 and D75 connected thereto, thus, SW16 can simply control conduction of electric current during the positive half cycle without affecting the control of the negative half cycle, and therefore it can control the potential of AC-SW1 in FIG. 8(b) to further achieve function of group switching; switch S17 simply controls conduction of electric current during the negative half cycle without affecting the control of the positive half cycle, and therefore it can control the potential of AC-SW2 in FIG. 8(a) to further achieve dimming control. In other words, the present circuit enables one original lamp ON-OFF switch to be changed into two switches for group switching and dimming control.

Further, electronic touch switches can be used to substitute wall switches, enabling one single switch to be changed into two touch switches for group switching and dimming control. In the drawing, BD1 is a bridge rectifier for current output through the positive terminal either during the positive half cycle or negative half cycle. Output current goes through Q23 and E224 and D72 to charge C115; D73 is a 12V Zener. Thus, C115 is stabilized at 12V, and then regulated by buck regulator IC U55 into 5V. The invention deliberately designs the circuit to have the electric current for the positive half cycle to be different from that for the negative half cycle (current-limiting resistors R158 and R160 in FIG. 8(b) have different resistances; resistance of R158<resistance of R160, i.e., current at the negative half cycle is greater than that at the positive half cycle). In other words, the current passing through U54 at the negative half cycle is greater than that at the positive half cycle, i.e., different widths (cycles) of potential can be obtained from resistor R227, and the relatively wider is the negative half cycle. Microprocessor U58 determines the positive half cycle or negative half cycle subject to the time period of HI at R227. U55 is a touch IC. When a hand approaches KEY 1 (group), U58 controls the positive half cycle or negative half cycle to be ON or OFF subject to the time base signal provided by R227 in such a manner that it controls Q22 by means of R228. At the positive half cycle, if Q22 is ON, Q23 is changed to OFF, i.e., the positive half cycle is OFF. If Q22 is OFF at the positive half cycle, Q23 is changed to ON, i.e., the positive half cycle is ON. Thus, the potential of AC-SW1 is controlled. When the hand approaches KEY2 (dimming control), U58 controls the negative half cycle to be ON or OFF via Q22 and Q23, thereby controlling the potential of AC-SW2. The result is same as mechanical control, and therefore, group control and dimming control are achieved.

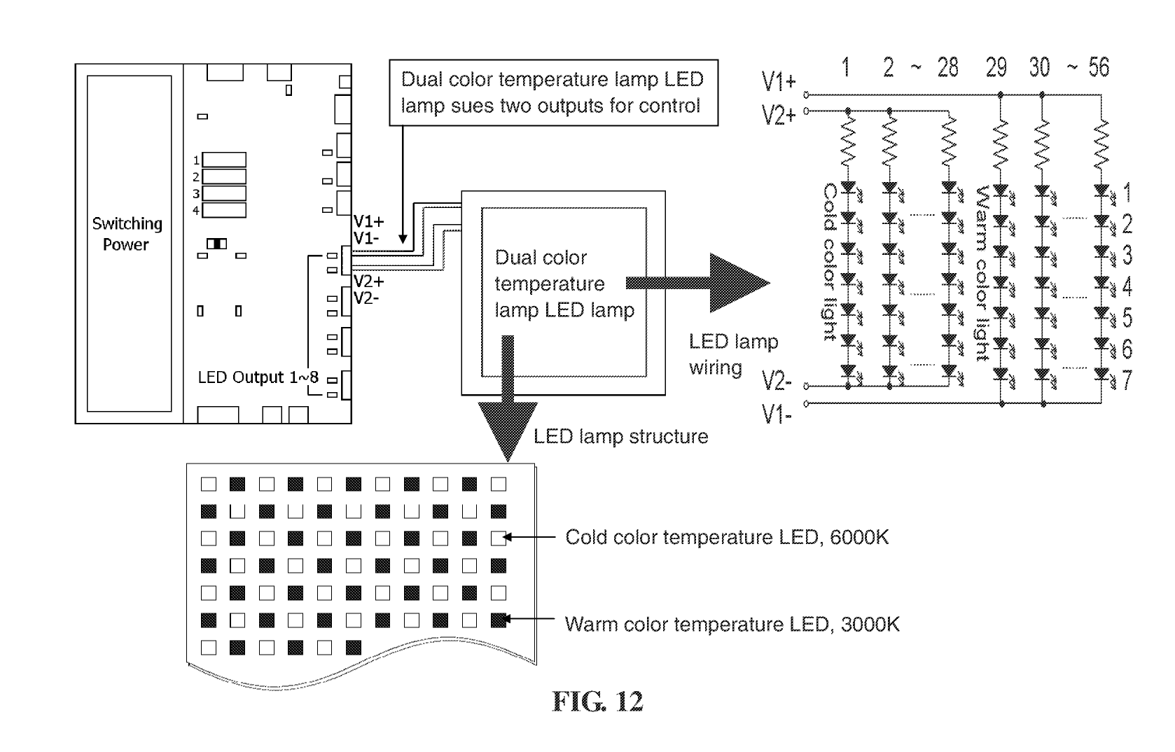

FIG. 12 is a schematic drawing illustrating the arrangement of a dual color temperature LED lamp in accordance with the present invention. Except the control of one single color temperature LED lamp, the invention can use two outputs to achieve dimming control of a dual color temperature LED lamp, as shown in FIG. 12. As illustrated, the dual color temperature LED lamp consists of two LED sets of different color temperatures in which the first LED set V+; V− is a warm color LED (color temperature 3000K), and the second LED set is a cold color LED (color temperature 6000K). The LED chips of the first and second LED sets are evenly distributed on a flat lamp panel in a crossed manner with the respective output terminals connected to LED-1 and LED-2 of the collective LED intelligent illumination control device. In other words, the output of LED-1 controls the brightness of the warm color LED set and the output of LED-2 controls the brightness of the cold color LED set, and therefore controlling dimming of LED-1 and LED-2 relatively controls the brightness and color temperature of this dual color temperature LED lamp, achieving fine-adjustment of the brightness and color temperature of one same lamp.

In conclusion, the invention provides a platform for the operation control and data collection of multiple LED lamps, allowing multiple LED lamps to use one common power supply, one common power measurement device, one common communication interface and one common scene control interface to share the cost. Either a 2-wire switch or 3-wire switch, the use of the present invention does not need to change the existing electrical wiring, upgrading the functions of existing wall switch and allowing group control and dimming control of multiple LED lamps subject to actual job-site requirements. Thus, the use of the invention saves power consumption, achieves intelligent and human-friendly control, and reduces the total cost. Further, the invention can be installed in the top side of a defined space. With the attached Zigbee module, the invention establishes an information collection platform for intelligent green building. While providing the function of intelligent lighting control, the invention can also help a an energy-saving and carbon-reduction green building to establish the desired information collection and control base for convenient operation.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A collective LED intelligent illumination control device, comprising a power converter for providing the necessary working power supply to a plurality of LED lamps, and a multipurpose controller for dimming control of each said LED lamp, said multipurpose controller comprising a power measurement module for measuring the power consumed by each said LED lamp and recording the measured data, a scene mode input interface in conjunction with at least one existing wall switch for group switching and multi-step dimming controls, and a built-in network card and a Zigbee communication interface for communication with a remote server for remote power and dimming controls and collection of power consumption data of each said LED lamp and for wireless communication with surrounding sensors and equipment for predetermined data collection and controls.

2. The collective LED intelligent illumination control device as claimed in claim 1, wherein said power converter and said multipurpose controller are separately mounted in a bottom plate and connected by means of electric sockets in such a manner that AC power supply of said power converter is provided after processed through said power measurement module of said multipurpose controller; DC power supply of said power converter is provided for the working of said multipurpose controller.

3. The collective LED intelligent illumination control device as claimed in claim 1, wherein said multipurpose controller further comprises a lighting control and status read interface and a built-in program for automatically calculating the electric current value for each dimming control step of predetermined multiple dimming control steps for setting of digital logic output for controlling said LED lamps that have different specifications and performance by means of weighted ratio shunting for conversion into linear voltage and constant current control of high-efficiency switching type power supply control to provide a stabilized DC voltage and DC current to each said LED lamp individually, avoiding flashing, noise production and transient overload driving, and prolonging the lifespan of said LED lamps.

4. The collective LED intelligent illumination control device as claimed in claim 3, wherein said power measurement module measures the data of voltage (V), current (A), power (W), real work (Wh) and power factor (PF) and cumulative power consumption of every said LED lamp and cumulative time of operation for data management, and determines the normality of the function of each said LED lamp by means of power measurement result of each said LED lamp.

5. The collective LED intelligent illumination control device as claimed in claim 4, wherein said power measurement module matches with said lighting control and status read interface and said built-in program to obtain the driving voltage for every dimming step for every said LED lamp and to use the data for establishment of a reference data.

6. The collective LED intelligent illumination control device as claimed in claim 1, wherein said scene mode input interface uses the existing wall switch electrical wiring to have power cables of said LED lamps be directly connected to terminals of said lighting control and status read interface for setting Dip switches of said scene mode input interface.

7. The collective LED intelligent illumination control device as claimed in claim 1, wherein the existing single wall switch is converted into two diode-contained mechanical switches for the control of positive half cycle power supply and negative half cycle power supply respectively to further achieve group control and dimming control.

8. The collective LED intelligent illumination control device as claimed in claim 1, wherein said scene mode input interface uses an electronic touch switch to achieve control by means of using two touch buttons to control ON/OFF (group) at the positive half cycle and ON/OFF (dimming) at the negative half cycle.

9. The collective LED intelligent illumination control device as claimed in claim 1, wherein said built-in network card and said Zigbee communication interface have connected thereto a big capacity memory card for storing power consumption data and current status data of each said LED lamp under control and transmitting the related data to a remote server via a TCP/IP interface for enabling said remote server to control ON/OFF and dimming of every said LED lamp, said memory card being adapted for recording power consumption data and operation time data of every said LED lamp for inquiry and establishment of data history.

10. The collective LED intelligent illumination control device as claimed in claim 2, wherein said multipurpose controller comprises an emergency switch switchable to a transient state position for power control.

11. The collective LED intelligent illumination control device as claimed in claim 1, wherein said multipurpose controller provides two dimming control outputs for regulating the brightness of a warm color temperature LED set and a cold color temperature LED set of each said LED lamp.
